(19) United States
(12) Patent Application Publication
(10) Pub. No.: US 2009/0121988 A1
(43) Pub. Date: May 14, 2009

(54) LARGE SCALE FLEXIBLE LED VIDEO DISPLAY AND CONTROL SYSTEM THEREFOR

(76) Inventors: Steve Amo, Oakville (CA); Aurel Cojocaru, Mississauga (CA); Dining Dai, Brampton (CA); Jun Feng, Toronto (CA); Wai Hung Leung, Markham (CA)

Correspondence Address: HAYES SOLOWAY P.C., 3450 E. SUNRISE DRIVE, SUITE 140, TUCSON, AZ, 85718, US

(21) Appl. No.: 12/301,010

(22) PCT Filed: May 15, 2007
(86) PCT No.: PCT/CA2007/000832

§ 371 Date: Nov. 14, 2008

Related U.S. Application Data
(60) Provisional application No. 60/747,397, filed on May 16, 2006.

(30) Foreign Application Priority Data
Nov. 3, 2006 (CA) 2,567,113

(51) Int. Cl. G09G 3/32; H04N 5/66

(52) U.S. Cl. 345/82; 348/739

(57) ABSTRACT

A flexible display for displaying images comprises a plurality of columns of pixel elements, each pixel element having display elements, a pixel driver for processing an output signal from a preceding adjacent pixel element in the same column and generating and transmitting an output signal to a succeeding adjacent pixel element in the same column; electrical conductors extending between pixel elements of each column for electrically connecting the pixel driver of the preceding adjacent pixel element to the pixel driver of the succeeding adjacent pixel element; an image signal processor for generating and delivering pixel element actuating signals to a first pixel element of each the column; and support connectors extending between adjacent pixel elements in the same column and between adjacent pixel elements of adjacent columns and permitting relative movement of the adjacent pixel elements.

### CROSS REFERENCE TO RELATED APPLICATION

This application claims priority from U.S. Provisional Patent Application No. 60/747,397, filed May 16, 2006 and Canadian Patent Application No. 2,567,113 filed Nov. 3, 2006, both of which are incorporated herein by reference.

### FIELD OF THE INVENTION

The present application generally relates to large scale illuminated video displays, typically for outdoor use, and more specifically to flexible, net-like displays or signs and, more specifically, to a control system and method of displaying images on display signs.

### BACKGROUND OF THE INVENTION

Conventional incandescent lamps, fluorescent lamps and neon tubes have long been used to illuminate large-scale commercial and public signs; however, the market is now demanding larger displays with the flexibility to customize display sizes and colors not possible with the older technologies. Consequently, many displays now use Light Emitting Diodes (LEDs) in their design because LEDs consume less electricity than conventional light emitters and have a longer lifetime with lower maintenance costs.

LED technology is currently being applied to large-scale display applications, such as outdoor or indoor stadium displays, large marketing advertisement displays, and mass-public informational displays. Many of these large-scale applications are dynamically reconfigurable under computer control. In addition, some large-scale animated displays capable of displaying video imaging are now being produced. Unfortunately, many currently available large-scale LED displays have limitations such as, for example, being particularly heavy, capable of being installed on only a limited number of surfaces, or exhibiting inferior performance.

Heretofore, LED displays were manufactured using a solid, rigid base for mounting pixel elements, and, therefore, had to be installed on a flat supporting structure using a dedicated frame and mounting hardware. The use of metal for construction of such a sign increased the weight of the structure and became a viewing obstacle for anything covered by it.

Accordingly, it would be advantageous to Improve LED displays. One approach to accomplish this is to provide a more lightweight system which would have the further advantage of being at least somewhat flexible, by providing a mesh-like array of pixel elements joined together in a mesh-like arrangement.

### SUMMARY OF THE INVENTION

A display is disclosed consisting of a plurality of columns of pixel elements, each pixel element having display elements and a pixel driver for processing a digital pixel data stream from a preceding adjacent pixel element in the same column, driving its associated light elements in accordance with the first unused pixel datum encountered, marking such datum as used and forwarding it to a succeeding adjacent pixel element in the same column.

Electrical conductors extend between pixel elements of each column for electrically connecting the pixel driver of the preceding adjacent pixel element to pixel driver of the succeeding adjacent pixel element.

Columns of pixel elements are driven by one of a series of daisy-chained column drivers, each of which in turn processes and forwards unmodified, a digital data stream, which involves extracting those portions of the data stream that correspond to columns with which the column driver is associated.

Support connectors extend between adjacent pixel elements in the same column and between adjacent pixel elements of adjacent columns and permit relative movement of the adjacent pixel elements.

The supports and interconnections of the constituent pixel elements permit a lightweight, reconfigurable, flexible and transparent display but preclude the use of conventional direct-addressing control systems for the display. The modular control system provided permits video data to be quickly propagated throughout the display elements without any hardware constraint upon the overall size or configuration of the display and in the absence of embuing any of the display elements with any knowledge of the overall size or configuration of the display.

### BRIEF DESCRIPTION OF THE DRAWINGS

These and other features of the invention will become more apparent from the following description in which reference is made to the appended drawings in which:

FIG. 1 illustrates, a front view of a plurality of pixel elements interconnected by a mesh of wires according to an example embodiment of the present invention;

FIG. 2 illustrates, in perspective, the interconnected mesh of pixel elements of FIG. 1;

FIG. 3 illustrates a back view of the interconnected mesh of pixel elements of FIG. 1;

FIG. 4 illustrates a side view of a plurality of pixel elements interconnected by a mesh of short wires according to another example embodiment of the present invention;

FIG. 5 illustrates, in rear perspective, the interconnected mesh of pixel element of FIG. 4;

FIG. 6 illustrates a front view of the interconnected mesh of pixel element of FIG. 4;

FIG. 7 diagrammatically illustrates a mesh sign control system structure for use with the interconnected mesh of pixel elements according to the embodiment of FIG. 1 and/or FIG. 4;

FIG. 8 diagrammatically illustrates the structure and functionality of a frame driver for use in the mesh sign control system structure of FIG. 7;

FIG. 9 shows an example data structure of a sector data frame for use in the mesh sign control system structure of FIG. 7;

FIG. 10 diagrammatically illustrates the structure and functionality of a column driver for use in the mesh sign control system structure of FIG. 7;

FIG. 11 shows an example data structure of a column data frame for use in the mesh sign control system structure of FIG. 7; and

FIG. 12 diagramatically illustrates the structure and functionality of a pixel driver for use in the mesh sign control system structure of FIG. 7.

### DETAILED DESCRIPTION

The present application will now be described for the purposes of illustration only, in conjunction with certain embodiments shown in the enclosed drawings. While preferred embodiments are disclosed, this is not intended to be limiting. Rather, the general principles set forth herein are considered to be merely illustrative of the scope of the present application and it is to be further understood that numerous changes covering alternatives, modifications and equivalents may be made without straying from the scope of the present application, as defined by the appended claims.

In particular, all dimensions described herein are intended solely to be exemplary for purposes of illustrating certain embodiments and are not intended to limit the scope of the invention to any embodiments that may depart from such dimensions as may be specified. Further, directional references such as “horizontal” or “vertical”, as well “column” are for convenience of description only. It will be understood that the device may be asserted in any direction.

### Overview

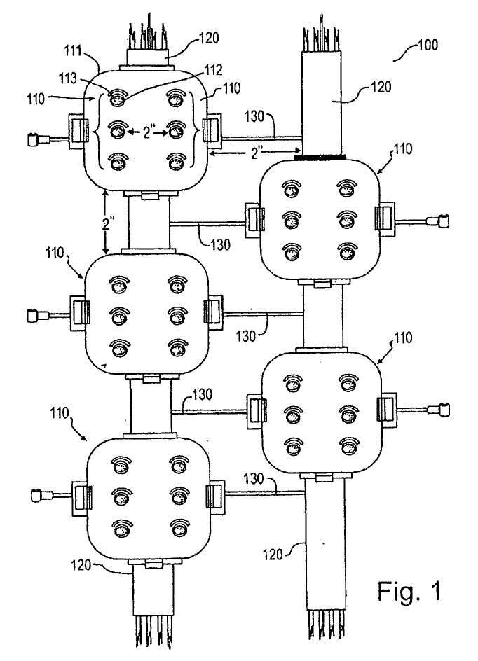

The present application relates to a mesh display structure, shown generally in FIG. 1 at 100, comprising at least one sector. Each sector consists of an array of m×n blocks, where a block is itself an array of p×q pixels. Preferably, the maximum image coverage of one sector is 640×256 pixels, comprising a 20×8 array of 32×32 pixel blocks. Within a single structure, different sectors may have different sizes of arrays of blocks, but the block sizes are the same across all sectors.

Within each sector, pixels spaced apart in the horizontal and vertical directions (assuming a vertical orientation to the display) are interconnected in a mesh of wires in the horizontal and vertical directions. The spacing between adjacent pixels determines the resolution of the display. For example, as shown in FIG. 1, each of a plurality of pixel housings 111 housing the pixels are physically separated by a short distance that may be, for example, 2 inches.

Thus, in the example 2 inch resolution embodiment under discussion, a sector may occupy up to a horizontal extent of 1278 inches (106.5 feet) and a vertical extent of 510 inches (42.5 feet). If a greater display size is desired, additional sectors could be added to the mesh display structure 100, either horizontally adjacent thereto, or conceivably, even vertically stacked upon one another.

As shown in FIG. 1, the pixel element 110 is housed in a compact and weatherproof self-contained housing 111, electrically connected to its immediately vertically adjacent neighbours by a network of flexible and visually discreet columnar strands of ribbon cable 120. Thus, the display structure 100 may be conceptually viewed as a plurality of (in this case columnar) strings of pixel elements 110. Those having ordinary skill in this art will appreciate that conceivably, a row-oriented structure could be implemented without departing from the spirit and scope of the present application.

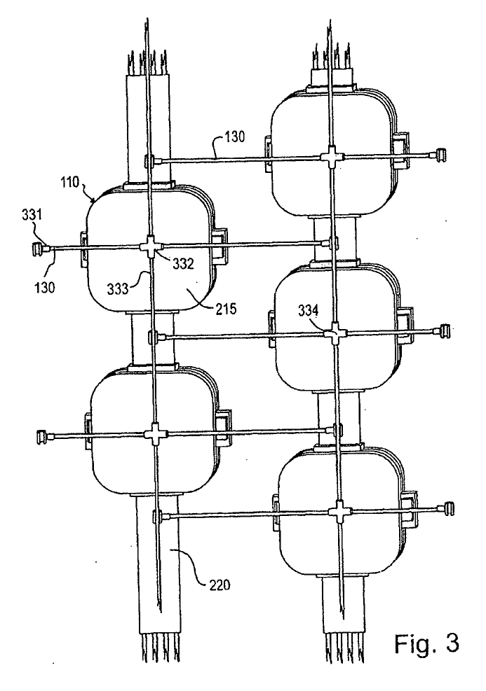

Vertical connector cables 333 tucked in behind (as better seen in FIG. 3) and immediately adjacent columnar strands 120 are structurally connected by horizontal connector cables 130 to form a sparse, flexible and visually discreet structural mesh.

This method of interconnection results in each housing 111 forming a small and relatively unobtrusive “knot” spaced apart substantially equally in the horizontal and vertical directions, in accordance with the desired resolution of the display structure 100, in a mesh structure that may be draped and/or secured to virtually any type, orientation and configuration of underlying surface or structure, such as the exterior vertical wail of an office tower, without blocking the view from behind the display 100.

Moreover, the mesh structure 100 allows natural light to pass through the display 100, permitting installation over glass structures such as windows in an office tower, so that a video image may be outwardly displayed without unduly darkening the office interior.

Furthermore, such display structure 100 has much less weight per unit area as compared to conventional display structures. Indeed, such display structure 100 provides a small (in terms of component size) and light unit, with few mechanical parts and electronic components, without derogating from the survivability of the structure 100 in harsh outdoor environments. The open structure of the net improves its ability to survive high winds and severe weather.

### Pixel Elements

Each housing 111 has provision for interconnection, with adjacent housings and enclosing, in a secure and weatherproof fashion, the electronic and electrical components thereof.

The housing 111 may be a three-part, flame retardant plastic enclosure with a pair of sealing gaskets and at least one opening 112 to accommodate a corresponding viewable light element. Optionally, the opening 112 and the light element 113 housed therein may be shielded by a clear lens which may be dome shaped.

Preferably, each of the light elements 113 is a light emitting diode (LED). More preferably, each of the pixel elements 110 comprises a plurality of differently coloured light elements 113, such as red, green, blue (RGB), in order to provide a colour display capability, each with a respective corresponding opening 112.

In FIG. 1, the differently coloured light elements 113 corresponding to a common pixel element 110 are vertically grouped. While such a grouping is shown and may be preferred, those having ordinary skill in this art will appreciate that other groupings may be equally applicable and that the choice of grouping may not be visually significant or differentiate.

Depending upon the resolution of the display 100, it may be advantageous, as is shown in example fashion in FIG. 1, to combine a plurality of pixel elements 110, suitably spaced apart, into a single housing 111 and sharing a common columnar strand 120. In FIG. 1, a two-pixel element housing is shown, each pixel comprising a group of three vertically aligned coloured light elements (RGB) and being laterally separated by the resolution of the structure 100, which is, for example, 2 inches. This multi-pixel element housing 111 is of a sufficient size to accommodate the electronics and control circuitry used to drive and control the LEDs 113 for both pixel elements, and reduces by half, the amount of mechanical and electrical cabling, at a cost of possibly a slightly larger housing 111.

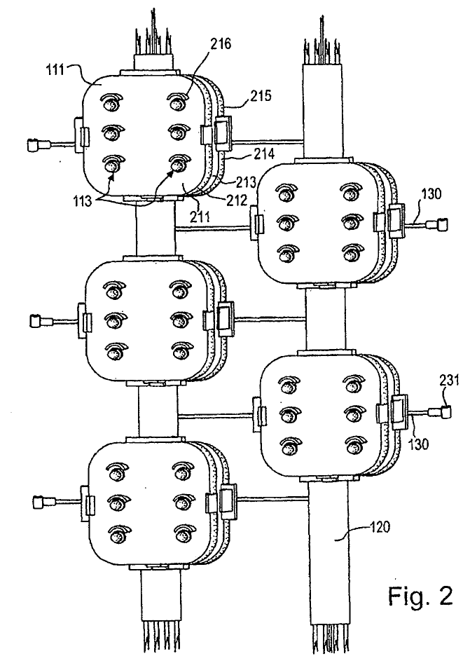

The electronics and control circuitry used to drive and control each pixel element 110, as discussed below, is stored within the housing 111, preferably on a printer circuit board (PCB) 213 as shown in FIG. 2 on which the various LEDs 113 may be mounted. The PCB 213 is sandwiched between a base 215 and a top component 211 of the housing 111, separated by gaskets 212, 214.

Preferably, again as shown in FIG. 1, the housings 111 of adjacent columnar strands 120 may be vertically offset by 50% so as to improve the spacing between proximal pixel elements 110 and thus, the overall transparency of the display structure 100.

### Structural Connectors

As may be better seen in FIG. 3, one end of each of the horizontal connectors 130 terminates in a C-shaped hook element 331 adapted to engage a vertical connector 333 in a pivotable removable snapping fit at one end, and a four connector bracket 332 secured to the base 215 of the housing 111 by a screw 334. Vertical connectors 333 extend between and securely engage the connector bracket 332 of vertically adjacent pixel elements 110. Preferably, the vertical connectors 333 are colinear with the columnar strands 120 so as to be obscured thereby when viewed from the front and to present a neat appearance.

The horizontal connectors 130, vertical connectors 333 and the hook elements 331 and connector brackets 332 combine to form a supporting mesh structure for the display structure 100 and especially the pixel element housings 111 thereof. Preferably, the horizontal connectors 130 and vertical connectors 333 are composed of aviation-quality cable wire, which has been shown to provide sufficient strength and support, while at the same time being lightweight, unobtrusive, relatively impervious to the outdoor elements and providing some degree of flexibility.

The use of C-shaped hook elements 331 to engage the vertical connectors 333 permit the pixel element housings 111 corresponding to one columnar strand 120 to pivot relative to the pixel element housings 111 corresponding to an adjacent columnar strand 120 and thus be easily configurable to be draped around angular and circular structures, such as corners and bends of a building structure.

Those having ordinary skill in this art will readily appreciate that where the pixel element housings 111 of adjacent columnar strands 120 are not offset, the hook elements 331 may be dispensed with and each horizontal connector 130 will terminate at and securely engage the connector brackets 332 of horizontally adjacent elements (not shown). However, such configuration will reduce the ability of the mesh structure 100 to be conveniently draped across non-planar structures because of the absence of any pivoting capability.

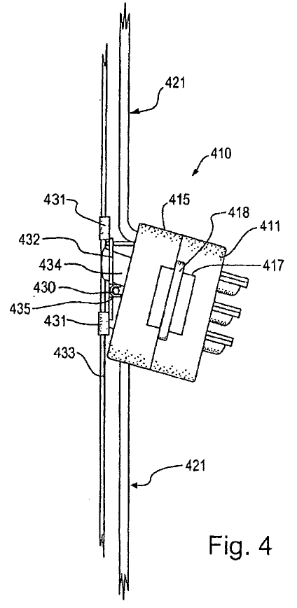

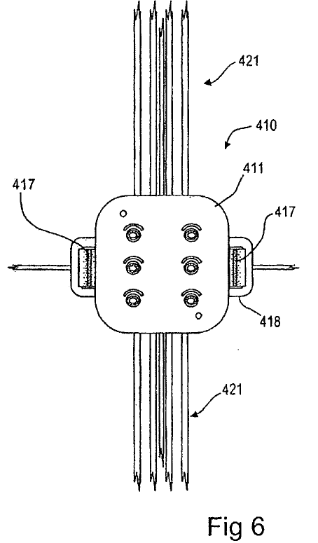

Turning now to FIGS. 4 through 6, there is shown an example embodiment of a housing 410 for use in the mesh display structure 100. Housing 410 comprises two portions, namely a top portion 411 and a bottom portion 415. The two housing portions 411, 415 may be secured together by means of a hook element 417 that extends from the bottom portion 415 to engage a receptor 418 in the top portion 411. Again, two groups 114 of light elements 113 project from an outer face of the top portion 411.

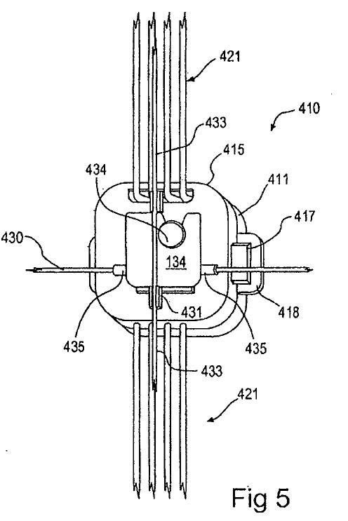

However, rather than a multi-conductor ribbon cable columnar strand 120, a plurality of separate electrical wires (in the example of FIG. 5, 4 wires (power, ground, serial data and serial dock respectively) emanating from the next lower vertically adjacent housing 410 enter the bottom portion 415 through corresponding openings and a further plurality of separate electrical wires emanate from corresponding openings in the bottom portion 415 and extend to the next higher vertically adjacent housing 410. Those having ordinary skill in this art will appreciate that the separate wires may be optionally enclosed by a cable harness (not shown).

In this example embodiment, longitudinal structural wires 433 are provided for supporting the housing 410. Hook elements 431 are secured to the wires 433 and to a bracket 432 which is detachably secured to the back side of bottom portions 415 by a pin 434 extending from the back of bottom portion 415. Transverse structural wires 430 extend through hooks 435, which are secured to bracket 432.

By this arrangement, the housing 410 is free to pivot about both longitudinal wires 433 and transverse wires 430 to provide a relatively freely flexible configuration. In this example embodiment, housings 410 in horizontally adjacent columns are not offset relative to one another.

### Electrical Connectors

With a maximum sector size of 640 pixels wide by 256 pixels high, there is a plurality of sets of columnar strands 120 interconnecting a vertically oriented serial string of pixel element housings 111. In the embodiment, shown in FIG. 1, wherein each housing 111 comprises two pixel elements 110, there would be a total of 320 sets of columnar strands 120.

Each of these sets of columnar strands 120 may have associated therewith up to 256 pixel elements 110, the maximum height of a sector in the example embodiment of FIG. 1.

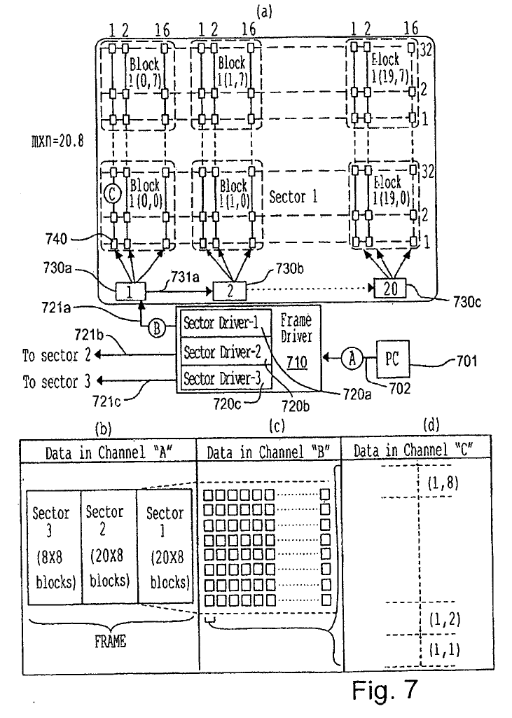

Pixel elements 110 corresponding to a given set are daisy-chained together by columnar strands 120 that extend between consecutive pixel elements 110, entering the housing 111 at a bottom opening and exiting the housing 111 at a top opening. As discussed below, the columnar strand 120 entering the lowest pixel element 110 in a given portion of a given vertical column may exit from a column driver module. While the example embodiments herein describe the column driver module 730 (FIG. 7(a)) as being situated below the pixel elements in a given vertical column, those having ordinary skill in the art will appreciate that the column driver module 730 could conceivably be situated anywhere relative to the pixel elements in the portion of the column other than the bottom, for example, the top, or at a point intermediate the top and the bottom, without departing from the spirit and scope of the present invention.

Each of the columnar strands 120 comprises a ribbon or similar cable comprising conductors for power and serial data for propagation throughout the pixel elements 110 associated therewith.

A power distribution unit is part of a Column Driver (as is shown in FIG. 7). It is located along the bottom extremity of the display structure 100 in a watertight enclosure, provides power for distribution to ail of the components, including 32 columns of pixel elements 110, by power cables that form part of the ribbon cable.

The power cable is daisy-chained between successively vertically adjacent pixel elements 110 in a portion of a vertical column, and will drive each circuit contained therein and associated with one of the plurality of constituent light elements 113. In this way, power may be distributed through the display structure 100, without significantly obscuring the display 100 or its transparency.

Every power cable for a column of pixel elements 110 is protected by an in-line fuse inside a Column Driver.

Each of the pixel elements 110 also has an associated serial data line. Thus, in the example embodiment of FIG. 1, the four wires are power, ground, serial data and serial clock. Successively vertically adjacent pixel elements 110 in a portion of a vertical column are serially daisy-chained.

### Control Structure

Because of the sparse, flexible and visually transparent nature of the mesh display structure 100, conventional mechanisms for controlling large display structures by way of direct pixel addressing are not implemented herein. To provide direct pixel addressing in a display structure, a plurality of row and column address buses would be called for, which would introduce a plethora of additional cables. Such additional cables would not only detract from the sparse, transparent and visually clean appearance of the mesh display structure, but would significantly increase the weight of the structure and degrade the flexibility thereof, thus limiting the scope of structures on which the mesh display structure 100 may be draped or installed.

In conventional, modular rigid displays, power supplies and controlling circuits are evenly distributed throughout the surface of the sign.

Furthermore, the use of direct pixel addressing imposes limitations on the expandability of the display structure resolution. As discussed below, a number of DSP (Digital Signal Processor) controllers process, transmit and receive digital picture or video data. These circuits are located in such a way as to be “invisible” in the mesh of pixels without altering the flexibility of the system. Preferably, they are situated at one extremity of the display structure 100. In the example embodiment of FIG. 7, both the DSP controllers and the power distribution unit (not shown), forming a Column Driver, are located along the bottom extremity of the display structure 100, in watertight enclosures.

Rather than provide direct pixel addressing, the mesh display structure 100 implements display control by serial data transfer of display and control data in a daisy-chain fashion. In so doing, only a small number of cables are called for (4 in the example embodiment of FIG. 1) and the display structure 100 may be easily increased in size and/or resolution by addition of further modular sectors without increasing the number of cables.

However, to reduce the propagation time for transmitting display and control data serially across each pixel of the mesh display structure, some parallelism is introduced at some stages in accordance with the structure of the display 100.

In the case of the example embodiment of FIG. 1, the display structure 100 is organized into one or more sectors, each comprising a maximum of 640 pixels wide by 256 pixels high, which may be a curved or other non-rectangular shape.

Each sector is divided into a plurality of strings. In the example embodiment of FIG. 1, the strings are vertically oriented and correspond to columns. In a sector of maximum size of 640 pixels wide by 256 pixels high, there may be as many as 640 columns.

Each column represents a number of serially connected pixel elements 110. In the embodiment of FIG. 1, each of the columns comprises 256 pixel elements 110.

The control structure corresponds roughly to the structure of the display 100. As shown in an example embodiment in FIG. 7(a), it comprises a frame driver 710, a plurality of sector drivers 720a, 720b, 720c, corresponding to the number of sectors in the display 100, a plurality of string drivers (in this case column drivers) 730a, 730b, 730c corresponding to the number of columns of blocks in the display 100 (that is to say, in the embodiment of FIG. 7(a), in which a sector of 20×8 blocks is shown, there are 20 column drivers 730a, 730b, 730c) and a plurality of pixel drivers 740 corresponding to the number of pixels in the display 100.

### Frame Driver

The frame driver 710 is connected to a personal computer 701 or other image data generating device by a video cable 702. As will be discussed below, the sector drivers 720 form part of the frame driver 710 and have suitable connections therewith by which video data may be passed from the frame driver 710 to each buffer of the sector driver 720.

The frame driver 710 accepts as input along video cable 702, a plurality of frames of display data for display on the display structure 100. As shown by way of example in FIG. 7(b), each frame represents a visual image to be displayed on the entirety of the display structure 100 at a given point in time. Video images may be represented as a series of frames that are displayed in quick succession to convey the sense of movement in well known fashion.

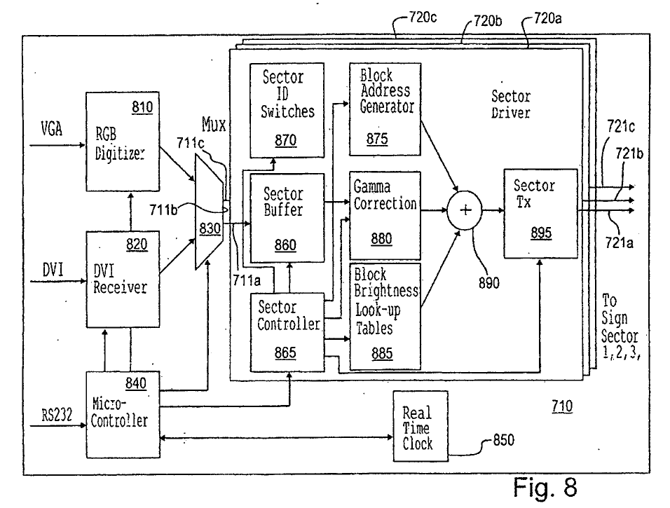

The source image frame data received by the frame driver 710 from the PC 701 may be in analog or digital form. As shown in FIG. 8, the frame driver 710 comprises one or both of an RGB digitizer 810 and a digital visual interface (DVI) receiver 820. The RGB digitizer 810 accepts an analog output signal (for example a VGA signal) from a graphics card on the PC 701 and converts ft into digital RGB signals, while the DVI receiver 820 accepts a DVI signal from a graphics card on the PC 701 and decodes it to digital RGB signals. If both the RGB digitizer 810 and the DVI receiver 820 are present, their respective outputs are multiplexed together at a multiplexer 830.

In addition, the frame driver 710 comprises a micro-controller 840, one or more sector drivers 720, and a real time clock (RTC) 850 to provide calendar and real time features. The micro-controller 840 communicates with the PC 701 through a RS232 port to control the operation of the display. The micro-controller 840 stores ail configuration data in its non-volatile memory. These data describe the properties and the operation of the display, such as the pixel pitch; the brightness and contrast of the display; the size and location of the image a particular sector driver should buffer; the configuration data for the RGB digitizer and the real time clock, etc,

The RGB digitizer 810 accepts an input analog signal from the PC 701 and outputs a digital output, signal to a first input of the multiplexer 830. The DVI receiver 820 accepts an input digital signal from the PC 701 and outputs a digital output signal to a second input of the multiplexer 830. The multiplexer 830 receives digital inputs from the RGB digitizer 810 and the DVI receiver 820 respectively and forwards one of them to the sector driver 720. It also receives a control signal from the micro-controller 840 by which it determines which signal is forwarded to the sector driver 720. The micro-controller 840 uses time and date information read from the real time clock 850 to perform brightness adjustment automatically. The micro-controller 840 provides the configuration data to the RGB digitizer 810, the DVI receiver 820 and the real time clock 850.

There is one uniquely addressable sector driver 720 for every sector of the display structure 100. In the example embodiment of FIG. 7(a), a three sector display is envisaged, with sectors 1 and 2 comprising the maximum size of 20×8 blocks of 32×32 pixels each and sector 3 comprising a smaller size of 8×8 blocks of 32×32 pixels each.

The frame driver 710 receives a complete frame of a data source image to be displayed on the display structure 100, if necessary converts it from analog to digital form, sends the data of a complete frame to all of its constituent sector drivers.

### Sector Driver

Each sector driver 720a, 720b, 720c is connected to and preferably forms part of the frame driver 710, and is connected to a corresponding first column driver in each sector (the first column driver 720a in sector 1 is shown in FIG. 7(a)) by a corresponding serial line 721a, 721b, 721c.

The streams of data from the source frame image are directed by the frame driver 710 to the sector drivers 710a, 710b, 710c of the sectors with which they are associated. The data are sent in RGB 24 bit format, (red, green and blue, 8 bits per colour), in progressive scan order, that is, top to bottom and left to right.

As shown in FIG. 8, each sector driver 720 comprises a sector buffer 860, a sector controller 865, a plurality of sector ID switches 870, a block address generator 875, a gamma correction module 880, a block brightness module 885, an adder 890 and a sector transmitter 895.

The sector controller 865 controls the sector buffer 860 to buffer a portion of the frame data from the multiplexer 830.

The size and origin of the buffered portion within a frame are determined by the sector's configuration parameters. For example, if a sector driver is configured with the size of width=20 blocks, height=15 blocks and the origin of X0=100 and Y0=50, since a block size is 32×32, it only buffers the data belonging to the portion of line from 50 to 50+32×15 and column from 100 to 1,00+32×20.

The sector driver 720 re-organizes the buffered image data into blocks of (in the case of the example embodiment of FIG. 7), 32×32 pixels each by calculating proper offsets both horizontally and vertically and applying these offsets to generate the memory addresses when reading the buffered data.

The sector controller 865 generates timing signals to control the sector buffer 860, the block address generator 875, the gamma correction module 880, the block brightness module 885 and the sector transmitter 895.

The sector ID switches 870 set the sector ID. All sector configuration parameters are encoded with an ID. A sector controller 865 only stores the parameters with a matching ID.

The block address generator 875 accepts as input an address timing signal from the sector controller 865 and generates a two-dimensional block address (x,y) reflecting the horizontal and vertical coordinates of the block relative to a reference position within the sector (in the example embodiment of FIG. 7, the lower left, corner thereof) to the adder 800 to be added to the block of data.

The sector controller 865 stores three gamma correction look-up tables, one for each colour in the gamma correction module 880 and uses these tables to apply gamma correction to every colour value of an input pixel and outputs the gamma corrected data to the adder 890. The gamma correction module 880 forwards the corrected pixel data to the adder 890.

Each block in a display can be white-balanced individually. The sector controller 885 stores these block-white-balance parameters in the block brightness module 885. The block brightness module 885 accepts as input the timing signal from the sector controller 865 and outputs the selected block brightness value to the adder 890.

The adder 890 accepts as input and combines the gamma corrected pixel data from the gamma correction module 880, the block address from the block address generator 875 and the block brightness value from the block brightness module 885 and forwards the resulting data stream to the sector transmitter 895.

The sector transmitter 895 accepts the data stream from the adder 890, serializes and forwards it to the column drivers 730 of the sector through serial communication.

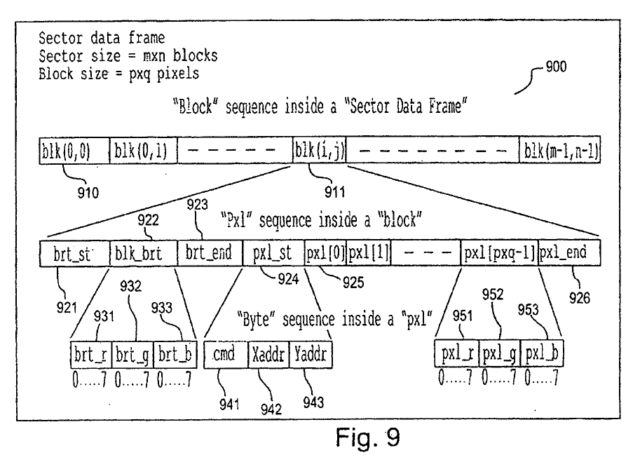

An example data format of the sector data frame 1000 transmitted by the sector transmitter 895 is shown in FIG. 9. It comprises a series of block data frames 910, corresponding to each of the blocks in the sector. In the example embodiment of FIG. 7(a), where sector 1 is of dimension 640 pixels wide by 256 pixels high and the block size is 32 pixels by 32 pixels, there are 20 rows and 8 columns of blocks, or 160 blocks in total.

Each block data frame 910 comprises a series of 3 byte symbols, called “pxls” 911, which may be categorized into one of three types, namely command pxls, brightness pxls and pixel pxls.

There are four command pxls 911 in a block data frame, namely “brt_st” 921, “brt_end” 923, “pxl_st” 924 and “pxl_end” 925. The “brt_st” 921 denotes the start of a series of three brightness pxls 911 and the “brt_end”l 923 denotes the end of this series. Similarly, the “pxl_st” 924 denotes the start of a series of pixel, pxls 911 and the “pxl_end” 925 denotes the end of this series. In the example embodiment of FIG. 7(a), in which each block is 32 by 32 pixels, there would be 1024 pixel pxls 911 in a block data frame 900.

Preferably, the “brt_st” 921, “brt_end” 923, “pxl_st” 924 and “pxl_end” 926 pxls have unique and recognizable data patterns, for example: brt_st=(9,x,y), brt_end=(9,255,255), pxl_st=(8,x,y), and pxl_end=(8,255,255), where the two-byte (x,y) is a zero-offset (x,y) block address 942, 943 marking the position of the block within the sector relative to a reference point (in the example embodiment of FIG. 7(a), the bottom left corner of the sector).

For example, when a column driver receives a command pxl, it examines the block address (x,y) embedded inside the pxl. If the block address (x) matches the column driver's corresponding ID switch, the column driver opens its data buffer to store the following pxls. If the command pxl is brt_st 921, the following pxls will be saved as brightness values. If the command pxl is pxl_st 924, the following pxls will be saved as pixel values. When either brt_end or pxl_end command are received, a column driver closes its data buffer and ignores any subsequent pxls

The brightness pxls 911 comprise three bytes of brightness values, one byte for each of the red 931, green 932 and blue 933 colours. The values of the brightness levels represent the relative intensity of the entire block of pixels as against the intensity of other blocks. Individual intensity values within a block are represented by pxl values for individual pixels.

Each of the pixel pxls 925 comprise three bytes of intensity values, again corresponding to each of the red 951, green 952 and blue 953 colours. The individual intensity value multiplies the corresponding block intensity value to arrive at the overall intensity value.

Those having ordinary skill in this art will readily appreciate that a 24-bit gray scale intensity value could be stored as the block brightness pxl 911 and/or the individual pixel pxl 911 for monochrome display embodiments.

The pixel pxls 911 are preferably organized in a sequence that facilitates decoding into columns. For example, in the example embodiment of FIG. 7(a), a suitable sequence consists of each of the pxls in the block, moving from left to right and by rows, top to bottom.

Preferably, the data both within and between blocks is organized in a column-wise fashion. In the example embodiment of FIG. 7(a), in which block numbering is shown as being from a top to bottom and left to right direction, the data may be conveniently organized in a similar manner.

### Column Driver

Each of the pixel columns in a sector of the display structure 100 is controlled by a string or column driver 730. Preferably, the column driver 730 is located at an extremity (in the example embodiment of FIG. 7(a), the bottom extremity) of the set of columnar strands 120 interconnecting a vertical series of pixel element housings 111.

As shown in the example embodiment of FIG. 7(a), the first column driver 730a in sector 1 is connected to sector driver 720a by serial line 721a and to the second column driver 730b in sector 1 by a serial line 731a. Each column driver 730b, 730c is in turn connected to its immediately previous column driver 730a, 730b in daisy-chain fashion by corresponding serial lines 731a, 731b.

Moreover, each column driver, for example 730a is connected to each of a plurality of pixel drivers 740a 740b 740c by corresponding serial cables 732a, 732b, 732c. Thus, in the embodiment of FIG. 7(a), each of the 20 column drivers for sector 1 will be connected to 32 pixel drivers 740. Preferably, the pixel drivers 740 so connected to their associated column driver 730 are located at one extremity (in the example embodiment of FIG. 7(a), the bottom) of the vertical serial string of pixel elements 740.

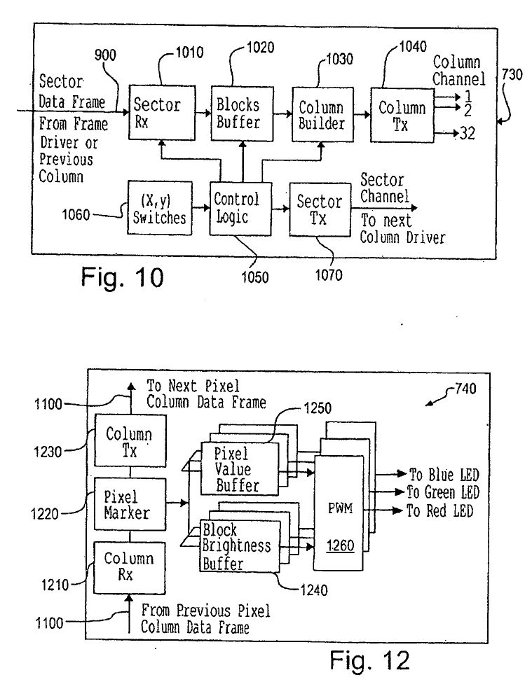

A block diagram of an example column driver 730 is shown in FIG. 10. It comprises a sector receiver 1010, a blocks buffer 1020, a column builder module 1030, a column transmitter 1040, a control logic module 1050, a plurality of ID switches 1060 and a sector transmitter 1070.

The sector receiver 1010 accepts a serial sector data frame from a source, which may be the sector transmitter 895 of the sector driver 720 or may be a sector transmitter 1070 of an upstream column driver 730.

The sector receiver 1010 determines from the appended block address whether or not it is to be processed by it. It makes this determination from the column driver ID, which it obtains from the control logic module 1050.

The column driver ID is a pair of zero offset integer values in the range from 0 to one less than the maximum number of row or column blocks in a sector (in the example embodiment, of FIG. 7(a), 20) generated by the ID switches 1060.

The control logic module 1050 compares the x coordinate of the column driver ID with the x coordinate 943 of the block address found in the “pxl_st” command pxl 924 of the block data frame. If there is a match, it forwards that block data frame 910 to the blocks buffer 1020 for processing.

The sector receiver 1010 concurrently forwards the entire sector data frame 900 to the control logic module 1050 for forwarding on to the sector transmitter 895 and thence to another downstream column driver 730. Thus, the sector data frame 900 is propagated in turn to each of the column drivers 730 in the daisy chain corresponding to a given sector, and each column driver 730 extracts those block data frames 910 corresponding thereto.

The blocks buffer 1020 accepts the block data frames 910 corresponding to a given column driver 730 from the sector receiver 1010 and buffers the blocks in increasing order of y-coordinate 942 of block address. The data in the blocks buffer, comprising not only the pixel pxls 911, but also the block brightness pxls 911, are accessible by the column builder 1030.

The column builder 1030 accesses data corresponding to a single column of pixels from the blocks buffer 1020. In a structure having a block size of p×q pixels, in which each block is encoded from left to right and then top to bottom , this consists of counting off the pixel pxls 911 of the block data frame 1010 a number of times corresponding to the column number 943 and taking a single pixel pxl 911, and then selecting every pth pixel pxl 911 thereafter.

The column builder 1030 thereafter processes the selected pixel pxls 925 into a stream of pixel data and forwards the resulting data stream as a string or column data frame 1100 to the column transmitter 1040.

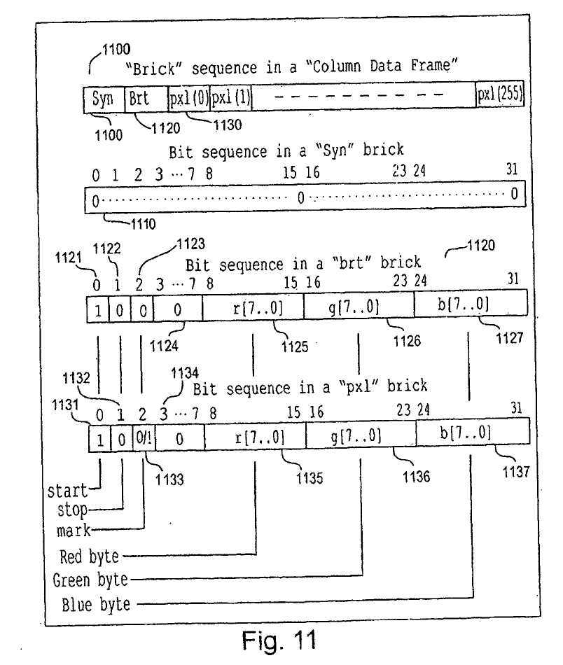

An example data format of the column data frame 1100 is shown in FIG. 11. Each column data frame 1100 comprises a series of 4 byte “bricks”, which may be categorized into one of three types, namely “syn” bricks 1110, “bit” bricks 1120 and “pxl” bricks 1130. A column data frame 1100 consists of a single “syn” brick 1110, followed by a single “brt” brick 1120, followed by a series of “pxl” bricks 1130, the number of which corresponds to the number of pixels in a column. For a sector of size m×n blocks and a block of size p×q, the number of pixels in a column is n×q. In the example embodiment of FIG. 7(a), there are n=8 block rows and q=32 pixel rows per block for a total of 256 pixels in a column of a sector. Consequently, in a column data frame suitable for use in such an example embodiment, there would be 256 “pxl” bricks 1130.

The “syn” brick 1110 acts as a synchronizing element and consists of a unique identifying pattern, for example, all 0s, to denote the start of a column data frame.

The “brt” brick 1120 contains three data bytes; corresponding to the three sets (for red 1125, green 1126 and blue 1127) of 8 bit block brightness values. Only the brightness values of the bottom block are saved and used. The remaining byte, preferably the first byte, contains a unique identifying pattern, for example, a “1” start bit 1121, a “0” stop bit 1122, followed by six dummy “0” bits 1123, 1124 to denote the start, of the “brt” brick 1120.

Each “pxl” brick 1130 also contains three data bytes, corresponding to the three sets (for red 1135, green 1136 and blue 1137) of 8 bit pixel intensity values to be multiplied to the corresponding block brightness value. The remaining byte, preferably the first byte, contains a unique. Identifying pattern, for example, a “1” start bit 1131, a “0” stop bit 1132, a “mark” bit” 1133, and five dummy “0” bits 1134 to denote the start of the “pxl” brick 1130.

The mark bit 1133 is a usage indicator that denotes whether the corresponding pixel, intensity values have been used before (for example, “0”) or are fresh and available for use (for example, when the column data frame 1100 is initialized by the column driver 730, each of the mark bits 1133 are initialized to “fresh” (“1”).

The column transmitter transmits the column data frame 1100 to the first pixel driver 740 in a daisy-chained string of pixel drivers 740 corresponding to the column. If, as postulated in the example embodiments shown and being described, the blocks buffer is organized in order of ascending x-coordinate of block address, and each block is organized in left to right and top to bottom order, then the pixel data in a corresponding column of the blocks buffer 1020 will represent in order, the pixel data to be displayed by a single column of a given sector of the display structure 100.

### Pixel Driver

Each of the pixel drivers 740 is housed in one of the pixel elements 110. There is one pixel driver in each pixel element. The pixel driver 740 connected to the column driver correspond to the first in a columnar string of pixels (in the embodiment of FIG. 7(a), the lowermost pixel in each column).

Each column driver 730a, 730b, 730c transmits a serial stream of pixel data to each of its associated first pixel drivers 740a, 740b, 740c along its associated serial cable 732a, 732b, 732c. The serial stream of pixel data in each case corresponds to an ordered (in the embodiment of FIG. 7(a), from the top of the column to the bottom) listing of pixel data corresponding to that column of pixels for the frame to be displayed.

Each of the first pixel drivers 740a, 740b, 740c is connected to its corresponding column driver 730a, by corresponding serial cables 731a, 731b, 731c and to the second pixel driver 742a, 742b, 742c , respectively, by corresponding serial cables 741a, 741b, 741c. Each pixel driver 742a, 742b, 742c is in turn connected to its Immediately previous pixel driver 740a, 740b, 740c in daisy-chain fashion by corresponding serial lines 741a, 741b, 741c and so on.

Each pixel driver 740 is an intelligent, self-contained device, which retrieves data from a previous, adjacent pixel driver 740 in the same column and sends data to the next adjacent pixel driver 740 in the column, While power and signals are generally described herein as traveling upwardly of a column, it is to be understood that power and signals could be distributed across rows, top down, or bottom up.

Referring now to FIG. 12, each pixel driver 740 comprises a column data stream receiver 1210, a pixel marker module 1220 and a column data stream transmitter 1230.

The column data stream receiver 1210 receives a column data frame 1100 from either a column driver 730 or the previous pixel driver 740 in the column and passes it on to the pixel marker module 1220.

The pixel marker module 1220 parses the “pxl” bricks 1025 in turn until it encounters a “fresh” (“1”) mark bit 1133. This signifies that the corresponding “pxl” brick 1130 has not been used. It then retrieves the corresponding block brightness brick and stores it in the block brightness buffer 1240 and retrieves the pixel data in the “pxl” brick 1130 and stores it in the pixel value buffer 1250. Thereafter, the pixel marker module 1220 marks the “pxl” brick as having being used (“0”) and forwards the entire column data stream 1100, suitably updated, to the column data stream transmitter 1230.

The column data stream transmitter 1230 in turn forwards the column data frame 1100 to the next immediately downstream pixel driver 740, if any still exist.

In the meantime, the Pulse-Width-Modulator (PWM) 1260

retrieves the RGB intensity values from the pixel value buffer 1250, multiplies them to their corresponding block brightness values from the block brightness buffer 1240 and generate control signals for the Red, Green and Blue LED display elements in accordance therewith.

Thus, each pixel driver 740 is responsible for performing three functions; (1) buffering a 24 bit RGB value and a 24 bit brightness value of the pixel; (2) adjusting the pixel colour and brightness of the LEDs to match these saved values in the column data stream; and (3) re-transmitting the received data to the next pixel driver 740 downstream in the same column.

Since pixel drivers 740 are not directly addressable, for the reasons set out above, they rely on the protocol to the effect that, the “pxl” brick corresponding thereto will be the first in the column data frame 1100 with a fresh marker bit 1133.

The present application can be implemented in digital electronic circuitry, or in computer hardware, firmware, software, or in combination thereof. Apparatus of the application can be implemented in a computer program product tangibly embodied in a machine-readable storage device for execution by a programmable processor; and methods actions can be performed by a programmable processor executing a program of instructions to perform functions of the application by operating on input data and generating output. The application can be implemented advantageously on a programmable system including at least one input device, and at least one output device. Each computer program can be implemented in a high-level procedural or object-oriented programming language, or in assembly or machine language, if desired; and in any case, the language can be a complied or interpreted language.

Suitable processors include, by way of example, both general and specific microprocessors. Generally, a processor will receive instructions and data from a read-only memory and/or a random access memory. Generally, a computer will include one or more mass storage devices for storing data file; such devices include magnetic disks and cards, such as internal hard disks, and removable disks and cards; magneto-optical disks; and optical disks. Storage devices suitable for tangibly embodying computer program instructions and data include ail forms of volatile and non-volatile memory, including by way of example semiconductor memory devices, such as EPROM, EEPROM, and flash memory devices; magnetic disks such as internal hard disks and removable disks; magneto-optical disks; CD-ROM and DVD-ROM disks; and buffer circuits such as latches and/or flip flops. Any of the foregoing can be supplemented by, or incorporated in ASICs (application-specific integrated circuits), FPGAs (field-programmable gate arrays) and/or DSPs (digital signal processors).

Examples of such types of computer are programmable processing systems contained in the PC 701, RGB digitizer 810, the DVI receiver 820, the micro-controller 840, the sector buffer 860, the sector controller 885, the block address generator module 875, the gamma correction module 880, the block brightness lookup module 885, the sector transmitter 895, 1070, the sector receiver 1010, 1210, the column builder 1030, the column transmitter 1040, 1230, the control logic module 1050, the pixel marker 1220, and the PWM 1260, suitable for implementing or performing the apparatus or methods of the application. The system may comprise a processor, a random access memory, a hard drive controller, and/or an input/output controller, coupled by a processor bus.

It will be apparent to those having ordinary skill in this art that various modifications and variations may be made to the embodiments disclosed herein, consistent with the present application, without departing from the spirit and scope of the present application.

Other embodiments consistent with the present application will become apparent from consideration of the specification and the practice of the application disclosed herein.

Accordingly, the specification and the embodiments disclosed therein are to be considered exemplary only, with a true scope of the invention being disclosed by the specification as a whole, including the following claims.

1-13. (canceled)

14. A video display for displaying at least one video image portion provided thereto, comprising:
a plurality of strings, each comprising a plurality of pixel elements, each pixel element containing a corresponding pixel driver and at least one light element, each of the pixel elements being electrically connected to a previous pixel element in the string and/or a subsequent pixel element in the string, each of the plurality of strings being interconnected with another of the plurality of strings by at least one transverse structural connector to form a lightweight flexible mesh adapted to be secured to a structure; and
a plurality of string drivers, each of the string drivers being electrically connected to a previous string driver and/or a subsequent string driver, each of the strings of pixel elements being electrically connected to one of the plurality of string drivers, the at least one video image portion being provided to a first of the plurality of string drivers;
wherein each of the plurality of string drivers is adapted to receive the at least one video image portion, extract at least one video image sub-portion corresponding to each of those strings of pixel elements electrically connected thereto, transmit the at least one video image sub-portion to the pixel driver of a first of the plurality of pixel elements in the corresponding string of pixel elements, and forward the entire at least one video image portion to its subsequent string driver, if any; and
wherein the pixel driver of each of the plurality of pixel elements in a string thereof is adapted to receive the at least one video image sub-portion, scan a usage indicator corresponding to each of a sequential series of image data contained therein until a first image datum having an unused status is identified, drive the at least one light element in accordance with the information contained in the first image datum having an unused status, modify the usage indicator of the first image datum having an unused status to reflect a used status and forward the entire video image sub-portion, so modified, to its subsequent pixel element, if any;
whereby the at least one light element in each of the plurality of pixel elements may be driven in accordance with the image data contained in the at least one video image portion, without having any knowledge as to its location in the plurality of strings.

15. A video display according to claim 14, wherein at least one of the pixel elements comprises a plurality of light elements.

16. A video display according to claim 15, wherein at least one of the pixel elements comprises a plurality of different coloured light elements.

17. A video display according to claim 14, wherein at least one of the light elements is a light emitting diode.

18. A video display according to claim 14, wherein at least one of the pixel elements is housed in a waterproof housing.

19. A video display according to claim 18, wherein each of the at least one pixel elements is associated with adjacent strings.

20. A video display according to claim 14, further comprising a plurality of structural connectors interconnecting at least two pixel elements of a string and substantially parallel with the string.

21. A video display according to claim 20, wherein at least one of the plurality of parallel structural connectors is disposed behind the string relative to a viewing surface of the display.

22. A video display according to claim 20, wherein one of the at least one transverse structural connectors is adapted to engage at least one of the plurality of parallel structural connectors.

23. A video display according to claim 22, wherein the one of the at least one transverse structural connectors is adapted to pivotally engage the at least one of the plurality of structural connectors.

24. A video display according to claim 22, wherein the one of the at least one transverse structural connectors is adapted to releasably engage the at least one of the plurality of parallel structural connectors.

25. A video display according to claim 14, wherein the pixel elements of one of the plurality of strings are horizontally offset relative to the pixel elements of a second one of the plurality of strings and immediately adjacent thereto.

26. A system for controlling a video display for displaying at least one video image portion provided thereto and comprising a plurality of strings, each comprising a plurality of pixel elements, each pixel element containing at least one light element, each of the pixel elements being electrically connected to a previous pixel element in the string and/or a subsequent pixel element in the string, each of the plurality of strings being interconnected with another of the plurality of strings by at least one transverse structural connector to form a lightweight flexible mesh adapted to be secured to a structure, the system comprising:
a plurality of pixel drivers in each of the pixel elements; and
a plurality of string drivers, each of the string drivers being electrically connected to a previous string driver and/or a subsequent string driver, each of the strings of pixel elements being electrically connected to one of the plurality of string drivers, the at least one video image portion being provided to a first of the plurality of string drivers;
wherein each of the plurality of string drivers is adapted to receive the at least one video image portion, extract at least one video image sub-portion corresponding to each of those strings of pixel elements electrically connected thereto, transmit the at least one video image sub-portion to the pixel driver of a first of the plurality of pixel elements in the corresponding string of pixel elements, and forward the entire at least one video image portion to its subsequent string driver, if any; and
wherein the pixel driver of each of the plurality of pixel elements in a string thereof is adapted to receive the at least one video image sub-portion, scan a usage indicator corresponding to each of a sequential series of image data contained therein until a first image datum having an unused status is identified, drive the at least one light element in accordance with the information contained in the first image datum having an unused status, modify the usage indicator of the first image datum having an unused status to reflect a used status and forward the entire video image sub-portion, so modified, to its subsequent pixel element, if any;
whereby the at least one light element in each of the plurality of pixel elements may be driven in accordance with the image data contained in the at least one video image portion, without having any knowledge as to its location in the plurality of strings.

27. A system according to claim 26, wherein the at least one video image portion is transmitted as a sector data frame.

28. A system according to claim 26, wherein the at least one video image sub-portion is transmitted as a string data frame.

29. A system according to claim 26, further comprising a frame driver for formatting a source video image into a digital pixel stream for distribution to the display.

30. A system according to claim 27, wherein the frame driver comprises a controller and at least one module for formatting the source video image, selected from a group consisting of an RGB digitizer and a DVI receiver.

31. A system according to claim 29, further comprising a plurality of sector drivers each for receiving a portion of the digital pixel stream and forwarding it to a first of a subset of the string drivers each connected one to another for distribution to the display as one of the at least one video image portions.

32. A system according to claim 31, wherein the portion of the digital pixel stream is divided into blocks.

33. A system according to claim 32, wherein the digital pixel stream is ordered so that the blocks are ordered in row-wise fashion in a left to right and bottom to top sequence relative to the display.

34. A system according to claim 32, wherein the digital pixel stream is ordered so that within a block, pixels are ordered in row-wise fashion in a left to right and bottom to top sequence relative to the display.

35. A system according to claim 32, wherein one of the plurality of sector drivers comprises a block address generator for annotating a block of pixels in the portion of the digital pixel stream with an address value whereby the block may be identified before forwarding it.

36. A system according to claim 32, wherein one of the plurality of sector drivers comprises a block brightness module for specifying a block brightness level to a block of pixels in the portion of the digital pixel stream before forwarding it.

37. A system according to claim 32, wherein one of the plurality of sector drivers comprises a gamma correction module for applying a contrast adjustment to at least one pixel in the portion of the digital pixel stream before forwarding it.

38. A system according to claim 26, wherein the usage indicator is a bit in the image datum.

39. A system according to claim 38, wherein the unused status is a “1” and the used status is a “0”.

40. A pixel driver for a video display for displaying at least one video image portion provided thereto,
the display comprising a plurality of strings, each comprising a plurality of pixel elements, each pixel element containing at least one light element, each of the pixel elements being electrically connected to a previous pixel element in the string and/or a subsequent pixel element in the string, each of the plurality of strings being interconnected with another of the plurality of strings by at least one transverse structural connector to form a lightweight flexible mesh adapted to be secured to a structure in each of a plurality of pixel elements; and
a plurality of string drivers, each of the string drivers being electrically connected to a previous string driver and/or a subsequent string driver, each of the strings of pixel elements being electrically connected to one of the plurality of string drivers, the at least one video image portion being provided to a first of the plurality of string drivers;
wherein each of the plurality of string drivers is adapted to receive the at least one video image portion, extract at least one video image sub-portion corresponding to each of those strings of pixel elements electrically connected thereto, transmit the at least one video image sub-portion to the pixel driver of a first of the plurality of pixel elements in the corresponding string of pixel elements, and forward the entire at least one video image portion to its subsequent string driver, if any;
the pixel driver corresponding to one of the at least one pixel elements and housed therein and being adapted to receive the at least one video image sub-portion, scan a usage indicator corresponding to each of a sequential series of image data contained therein until a first image datum having an unused status is identified, drive the at least one light element in accordance with the information contained in the first image datum having an unused status, modify the usage indicator of the first image datum having an unused status to reflect a used status and forward the entire video image sub-portion, so modified, to its subsequent pixel element, if any;
whereby the at least one light element in each of the plurality of pixel elements may be driven in accordance with the image data contained in the at least one video image portion, without having any knowledge as to its location in the plurality of strings.

41. A string driver for a video display for displaying at least one video image portion provided thereto,
the display comprising a plurality of strings, each comprising a plurality of pixel elements, each pixel element containing a corresponding pixel driver and at least one light element, each of the pixel elements being electrically connected to a previous pixel element in the string and/or a subsequent pixel element in the string, each of the plurality of strings being interconnected with another of the plurality of strings by at least one transverse structural connector to form a lightweight flexible mesh adapted to be secured to a structure in each of a plurality of pixel elements;
wherein the pixel driver of each of the plurality of pixel elements in a string thereof is adapted to receive at least one video image sub-portion of the at least one video image portion corresponding thereto, scan a usage indicator corresponding to each of a sequential series of image data contained therein until a first image datum having an unused status is identified, drive the at least one light element in accordance with the information contained in the first image datum having an unused status, modify the usage indicator of the first image datum having an unused status to reflect a used status and forward the entire video image sub-portion, so modified, to its subsequent pixel element, if any;
the string driver being electrically connected to a previous one and/or a subsequent one of a plurality of string drivers, each of the strings of pixel elements being electrically connected to one of the plurality of string drivers, the at least one video image portion being provided to a first of the plurality of string drivers, the string driver being adapted to receive the at least one video image portion, extract at least one video image sub-portion corresponding to each of those strings of pixel elements electrically connected thereto, transmit the at least one video image sub-portion to the pixel driver of a first of the plurality of pixel elements in the corresponding string of pixel elements, and forward the entire at least one video image portion to its subsequent string driver, if any;
whereby the at least one light element in each of the plurality of pixel elements may be driven in accordance with the image data contained in the at least one video image portion, without having any knowledge as to its location in the plurality of strings.

42. A method of controlling a video display comprising a plurality of strings, each comprising a plurality of pixel elements, each pixel element containing at least one light element, each of the pixel elements being electrically connected to a previous pixel element in the string and/or a subsequent pixel element in the string, each of the plurality of strings being interconnected with another of the plurality of strings by at least one transverse structural connector to form a lightweight flexible mesh adapted to be secured to a structure; and
a plurality of string drivers, each of the string drivers being electrically connected to a previous string driver and/or a subsequent string driver, each of the strings of pixel elements being electrically connected to one of the plurality of string drivers;
the method comprising the steps of:
(a) providing at least one video image portion to a first of the plurality of string drivers;
(b) each of the plurality of string drivers:
(i) receiving the at least one video image portion;
(ii) extracting at least one video image sub-portion corresponding to each of those strings of pixel elements electrically connected thereto;
(iii) transmitting the at least one video image sub-portion to the pixel driver of a first of the plurality of pixel elements in the corresponding string of pixel elements; and
(iv) forwarding the entire at least one video image portion to its subsequent string driver, if any; and
(c) the pixel driver of each of the plurality of pixel elements in a string thereof:
(i) receiving the at least one video image sub-portion;
(ii) scanning a usage indicator corresponding to each of a sequential series of image data contained therein until a first image datum having an unused status is identified
(iii) driving the at least one light element in accordance with the information contained in the first image datum having an unused status;
(iv) modifying the usage indicator of the first image datum having an unused status to reflect a used status; and
(v) forwarding the entire video image sub-portion, so modified, to its subsequent pixel element, if any;
whereby the at least one light element in each of the plurality of pixel elements may be driven in accordance with the image data contained in the at least one video image portion, without having any knowledge as to its location in the plurality of strings.
